(19) United States
(12) Patent Application Publication
(10) Pub. No.: US 2013/0300229 A1
(43) Pub. Date: Nov. 14, 2013

(54) COOLING JACKET HAVING A MEANDERING COOLING SYSTEM

(71) Applicants: Jörg Müller, Nudlingen (DE); Ardian Tropoja, Munnerstadt (DE)

(72) Inventors: Jörg Müller, Nudlingen (DE); Ardian Tropoja, Munnerstadt (DE)

(73) Assignee: Siemens Aktiengesellschaft, München (DE)

(21) Appl. No.: 13/981,278

(22) PCT Filed: Jan. 20, 2012
(86) PCT No.: PCT/EP2012/050848

§ 371 Date: Jul. 23, 2013

(30) Foreign Application Priority Data
Jan. 24, 2011 (EP) 11151808.0

(51) Int. Cl. H02K 9/19

(52) U.S. Cl. CPC H02K 9/19
USPC 310/54; 165/177; 165/172

(57) ABSTRACT

A cooling system for an electrical machine is produced in the form of an extruded profile and has a plurality of webs which run in the direction of the extrudate of the extruded profile. Each web separates two adjacent cooling channels of the cooling jacket from one another. The cooling channels of the cooling jacket form a meandering cooling system. Passages of the cooling system which run perpendicular to the webs are formed by in each case one cutout in each of the webs at one of the end faces of the cooling jacket or by cutouts in end plates which are attached to the end faces of the cooling jacket.

The present invention relates to a cooling jacket for an electrical machine, which is produced in the form of an extruded profile and has a plurality of webs which run in the direction of the extrudate of the extruded profile, each web separating two adjacent cooling channels of the cooling jacket from one another.

High-powered electric drive units are frequently fitted with appropriate cooling systems. In particular servomotors to be used as a traction drive unit for a motor vehicle are fitted with such cooling systems. Large-scale implementation and mass production of such cooling systems is often associated with major outlay. This entails corresponding costs. There is therefore a desire to be able to produce suitable cooling systems for electrical machines with the smallest possible production outlay.

It is also of major importance for the cooling systems of the electrical machines to have a high level of efficiency. This is frequently achieved by providing large thermal discharge surfaces in the cooling channels of the cooling system, to achieve an optimum cooling effect.

Highly effective cooling can be achieved in particular by means of liquid cooling agents. The cooling agents have to be closed off in an adequately sealed manner in the respective cooling system, as this is the only way of preventing coolant loss in the long term.

The problems mentioned above have been resolved in the following manner to date: in the case of a water-cooled housing motor cooling was achieved for example by way of the four corners of an extruded profile representing the cooling jacket or housing of the motor. The peripheral cover (i.e. the ratio of cooling surface to overall surface) of the cooling system here is only approx. 35% of the area or overall surface of the motor. The cooling effect is therefore correspondingly small. The seal between the end plates and the angular profile cooling jacket is achieved by way of a flat seal or using a liquid sealing means. Such sealing systems can cause problems at high pressures and temperatures.

The object of the present invention is therefore to propose a cooling system for an electrical machine that can be produced at low cost and has a high level of efficiency.

According to the invention this object is achieved by a cooling jacket for an electrical machine,
which is produced in the form of an extruded profile,
which has a plurality of webs which run in the direction of the extrudate of the extruded profile, wherein
each web separates two adjacent cooling channels of the cooling jacket from one another,
the cooling channels of the cooling jacket form a meandering cooling system and
passages of the cooling system which run perpendicular to the webs are formed respectively by
   one cutout in each of the webs at one of the end faces of the cooling jacket or
   cutouts in end plates which are attached to the end faces of the cooling jacket.

This advantageously allows an extruded profile, which can be produced at low cost, to be used for the cooling jacket. In one variant some webs are to be shortened or provided with cutouts only at end faces after extrusion, thereby ensuring a meandering cooling flow through the entire cooling jacket. In one alternative embodiment the end plate(s) is/are fitted with corresponding cutouts for diverting the cooling agent in a peripheral direction. In principle the techniques for diverting in a peripheral direction can also be combined. In other words cutouts can be provided in webs at the one end face of the cooling jacket, while cutouts are present in an end plate on the other side of the cooling jacket, ultimately ensuring that there is always a meandering coolant flow.

The cooling jacket is preferably configured as cylindrical. This has the advantage that the electrical machine, including the cooling jacket, can be formed in a very compact manner, as the actual electrical machine generally also has the form of a circular cylinder.

According to one alternative embodiment the cooling jacket can also be configured as prismatic, the base surface and top surface of the respective prism forming a polygon. in particular the base surface of such a prismatic cooling jacket can be configured as square. The corners of the cooling jacket or the electrical machine as a whole here are used many times to attach the electrical machine.

In one particularly preferred embodiment the cooling jacket is extruded from aluminum. This metal is characterized both by its low weight and also by its efficient thermal conductivity.

If an end plate is used to divert the cooling flow around the webs of the extruded profile, the end plate can be cast from aluminum or gray iron. Although gray iron has much higher strength values, aluminum is characterized, as mentioned above, by efficient thermal conductivity and lightness.

The inventive cooling channel can have at least three, in particular twelve cooling channels, which run parallel to one another in the direction of the extrudate. It is particularly advantageous here if the cooling jacket has two concentric jacket parts, which are essentially only connected to one another by the webs. This means that coolant flows through the cooling jacket almost everywhere on its periphery. This allows a correspondingly high level of cooling efficiency to be achieved. The number of webs should be selected to be as small as possible, it being necessary to ensure the required strength of the cooling jacket at all times.

As mentioned above, it is particularly favorable for an electrical machine to be fitted with such a cooling jacket. It can not only be an electric motor but also a generator. Not only rotary drives but also linear drives can be provided with the cooling jacket.

As far as the sealing problem is concerned, it is favorable for the cooling jacket to be configured as a circular cylinder and for the cooling channels at the end faces of the cooling jacket to be sealed by at least one O-ring per end face. O-rings on component boundaries essentially have the advantage that they are easier to mount and provide a more efficient seal. They are also easier to produce.

The present invention is now described in more detail with reference to the accompanying drawings, in which:

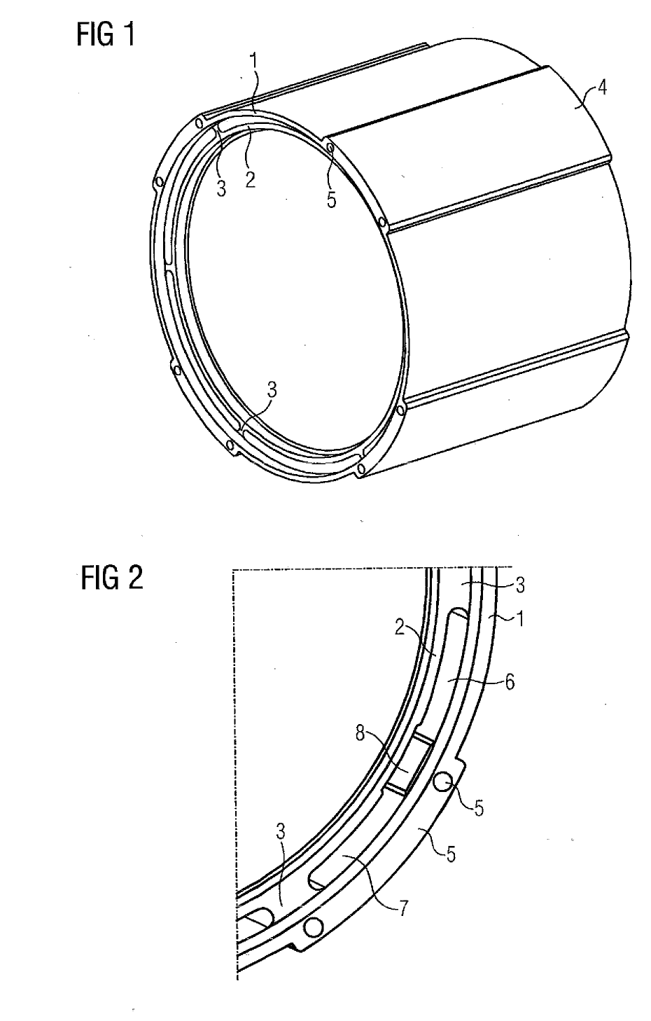

FIG. 1 shows an oblique view of an inventive cooling jacket produced in the form of an extruded profile;

FIG. 2 shows an enlarged view of a section of the end face of the cooling jacket from FIG. 1;

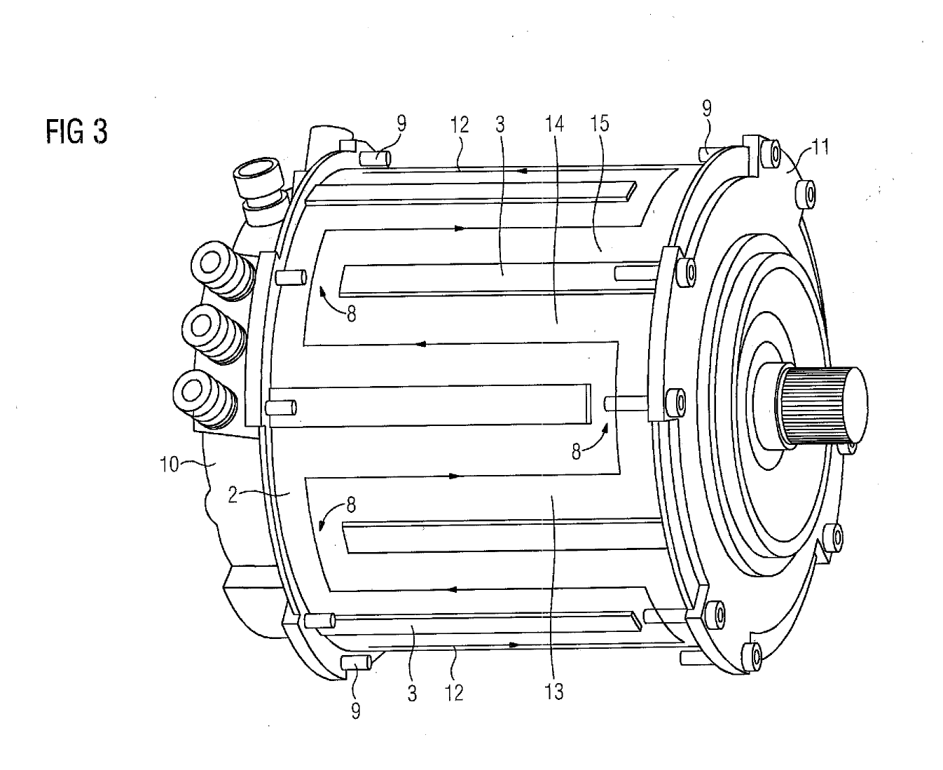

FIG. 3 shows an oblique view of a servomotor having a cooling jacket, the outer wall of the cooling jacket not being shown to reveal the meandering coolant flow and

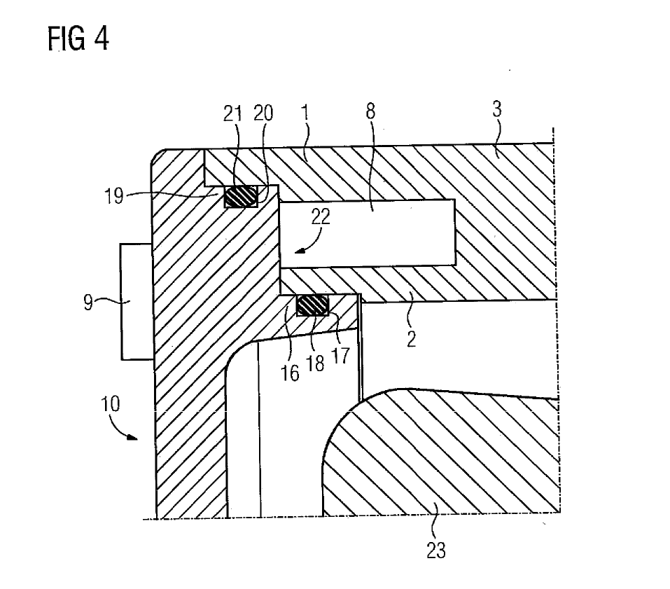

FIG. 4 shows a cross section through an end face of the cooling jacket and an end plate sealed thereon.

The exemplary embodiments described in more detail below represent preferred embodiments of the present invention.

FIG. 1 shows an oblique view of a tubular cooling jacket. The cooling jacket therefore essentially has the form of a jacket of a circular cylinder. It is embodied as double-walled and has a tubular outer wall 1 and a tubular inner wall 2 disposed concentrically thereto. The two walls 1 and 2 are separated from one another by webs 3. The webs 3 run in an axial direction in relation to the tube or cylinder form of the cooling jacket. This axial direction corresponds to the direction of the extrudate or the extrudate direction.

Provided on the outside of the outer jacket here are attaching elements 4, which can be used to attach the cooling jacket to end plates by means of axially running screws (see FIG. 3). To this end the attaching elements 4 have corresponding holes 5 in an axial direction.

Immediately after extrusion the cooling jacket has the same cross section at every axial point. This in turn means that the cooling jacket can be produced in any desired length without major outlay.

FIG. 2 shows a section from the end face of the cooling jacket from FIG. 1. The cooling channels 6, 7 are present between the outer wall 1 and the inner wall 2. All the cooling channels of the cooling jacket are delimited in a peripheral direction by webs 3. In the present example the cooling jacket has twelve cooling channels and therefore also twelve webs 3 in an axial direction.

In the example in FIG. 2 the end face end of the web 3 is milled out between the cooling channels 6 and 7 to produce a cutout 8. This cutout 8 allows coolant to flow from the cooling channel 6 into the cooling channel 7 (or vice versa), when the cooling jacket is closed at its end face. The cutout 8 therefore creates a connection between adjacent cooling channels 6, 7 in a peripheral direction. The cross section of the cutout 8 should be selected to be approximately the cross section of a cooling channel 6, 7 so that the flow resistance in the cooling channels 6, 7 is approximately identical to the flow resistance in the cutout 8. However if necessary the cross section of the cutout 8 can also be selected so that it is different.

FIG. 3 shows a servomotor having the inventive cooling jacket. However the outer jacket or outer wall 1 is not shown in the FIG, to reveal the coolant flow in the interior of the cooling jacket. Essentially the inner wall 2 of the cooling jacket is therefore visible, with webs 3 that project radially outward running in an axial direction on said inner wall 2. The cooling jacket is screwed with axially running screws 9 between two end plates 10 and 11. The screws 9 here are screwed into the holes 5 (see FIG. 1 and FIG. 2; not shown in FIG. 3).

FIG. 3 also clearly shows the cutouts 8 on the webs 3. The cutouts 8 are present in every second web 3 in a peripheral direction on the A-side end plate 11 and in the intervening webs 3 on the B-side end plate 10. This allows a meandering coolant flow 12 to be formed between outer wall 1 and inner wall 2. The coolant flow 12 therefore flows for example in an axial direction through a cooling channel 13 between two webs 3 to the A-side end plate 11. It is diverted at the end plate 11 and flows in a peripheral direction into the adjacent cooling channel 14. There the coolant flows counter to the flow direction in the cooling channel 13 in the opposite direction to the B-side end plate 11. It is diverted again there and pushed through a cutout 8 into the next adjacent cooling channel 15. The coolant flow continues thus in a meandering manner.

The regular meandering flow of the cooling medium around the servomotor is achieved by the cooling channels 6, 7 or 13, 14, 15 disposed all round the periphery of the servomotor. In the example in FIG. 3 the cooling medium is diverted through openings or cutouts 8 in the webs 3 at the end faces of the cooling jacket. Alternatively it is also possible for the cooling medium to be diverted at the end faces of the cooling jacket in the respective end plates. In this instance recesses are incorporated in the end plates in the region of the end surfaces of the webs 3. For example the end plates 10, 11 are cast from aluminum or gray iron and corresponding pockets are cast in the form of recesses to divert the coolant. The recesses are again distributed along the periphery so that the meandering coolant flow 12 results. The dimensions of the pockets in the end plates should again be selected with a view to a suitable flow resistance.

The entire coolant circuit is present exclusively within the cooling jacket apart from the fact that in one of the abovementioned embodiments the coolant flow can be diverted in the end plates.

The cooling jacket is closed off at the end face for example as shown in FIG. 4. FIG. 4 shows an axial longitudinal section through a web 3 of the cooling jacket at its end face, which is closed off by the end plate 10. It shows the outer wall 1 and the inner wall 2 of the cooling jacket, which are connected to one another by the web 3. Present in the web 3 is the cutout 8, through which the coolant can flow perpendicular to the plane of the drawing, in other words in a peripheral direction.

The side of the end plate 10 facing the cooling jacket is configured as staged. The cooling jacket itself has corresponding stages at its end face. A first stage 16 rests in a radial direction against the inside of the inner wall 2 or against a turned part thereof. The stage 16 has a groove 17 in a peripheral direction, into which an O-ring 18 is inserted. The O-ring 18 therefore seals the cooling system off from the inside of the motor. The seal between the first stage 16 and the inner wall 2 is specifically thus.

A second stage 19 is present radially further up and axially further out relative to the first stage 16. It rests radially against the outer wall 1 of the cooling jacket or a turned part thereof. It also has a groove 20 running in a peripheral direction, into which an O-ring 21 is also inserted. The O-ring 21 seals the second stage 19 off from the outer wall 1 and therefore seals the cooling system off from the outside world.

The cooling channels are closed off axially by an annular segment 22 of the end plate 10, which connects the first stage 16 to the second stage 19. This annular segment 22 is shown as a radially running wall in FIG. 4. Overall the staged nature of the end plate 10 and the end face of the cooling jacket forms a labyrinth seal.

FIG. 4 also shows a screw 9, which screws the end plate 10 to the cooling jacket. A winding head 23 of the electrical machine is also shown in the Figure.

The extensive meandering cooling system allows a high level of cooling efficiency to be achieved and therefore also a high power density of the motor or electrical machine. The O-rings also ensure simple and secure sealing of the cooling circuit. This also allows high pressures in the cooling system.

As the cooling jacket is produced from an extruded profile, the seal cannot be impaired due to cavities (typical hollow spaces formed during casting) or pores. There are therefore fewer failures due to such cavities or pores.

The extruded profile also means that the walls of the cooling jacket can be thin and the structure of the cooling system can therefore be very compact and economical. There is also a high level of flexibility in respect of the length of the cooling jacket and the interface requirements.

1.-8. (canceled)

9. A cooling jacket for an electrical machine, said cooling jacket being produced from an extruded profile and comprising:
a tubular outer wall;
a tubular inner wall arranged in concentric relationship to the outer wall;
a meandering cooling system having cooling channels;
a plurality of webs which run in a direction of an extrudate of the extruded profile to separate two adjacent ones of the cooling channels from one another and to distance the outer wall from the inner wall, said cooling system having passages which run perpendicular to the webs and are each formed by a cutout in the webs at an end face of the cooling jacket;
a staged end plate attached at an end face of the cooling jacket and having a first stage which rests in a radial direction against an inside of the inner wall, a second stage which rests radially against the outer wall at a location that is radially and axially outwards of the first stage, and an annular segment which connects the first stage to the second stage and axially closes the cooling channels;
a first O-ring received in the first stage for sealing against the inner wall;
a second O-ring received in the second stage for sealing against the outer wall; and
attaching elements disposed on an outside of the outer wall for mounting the cooling jacket to the end plate by axial screws.

10. The cooling jacket of claim 9, wherein the cooling jacket is configured as a circular cylinder.

11. The cooling jacket of claim 9, wherein the cooling jacket is configured as prismatic.

12. The cooling jacket of claim 9, wherein the extruded profile is made of aluminum.

13. The cooling jacket of claim 9, wherein the end plate is made from aluminum or gray iron by casting.

14. The cooling jacket of claim 9, wherein the cooling system has at least three cooling channels which run parallel to one another in the direction of the extrudate.

15. The cooling jacket of claim 9, wherein the cooling system has at least twelve cooling channels which run parallel to one another in the direction of the extrudate.

16. An electrical machine, comprising a cooling jacket being produced from an extruded profile and comprising a tubular outer wall, a tubular inner wall arranged in concentric relationship to the outer wall, a meandering cooling system having cooling channels, a plurality of webs which run in a direction of an extrudate of the extruded profile to separate two adjacent ones of the cooling channels from one another and to distance the outer wall from the inner wall, said cooling system having passages which run perpendicular to the webs and are each formed by a cutout in the webs at an end face of the cooling jacket, a staged end plate attached at an end face of the cooling jacket and having a first stage which rests in a radial direction against an inside of the inner wall, a second stage which rests radially against the outer wall at a location that is radially and axially outwards of the first stage, and an annular segment which connects the first stage to the second stage and axially closes the cooling channels, a first O-ring received in the first stage for sealing against the inner wall, a second O-ring received in the second stage for sealing against the outer wall, and attaching elements disposed on an outside of the outer wall for mounting the cooling jacket to the end plate by axial screws.

17. The electric machine of claim 16, wherein the cooling jacket is configured as a circular cylinder.

18. The electric machine of claim 16, wherein the cooling jacket is configured as prismatic.

19. The electric machine of claim 16, wherein the extruded profile is made of aluminum.

20. The electric machine of claim 16, wherein the end plate is made from aluminum or gray iron by casting.

21. The electric machine of claim 16, wherein the cooling system has at least three cooling channels which run parallel to one another in the direction of the extrudate.

22. The electric machine of claim 16, wherein the cooling system has at least twelve cooling channels which run parallel to one another in the direction of the extrudate.

23. The electrical machine of claim 16, wherein the first and second O-rings seal the cooling channels at end faces of the cooling jacket, respectively.
